(19) United States
(12) Patent Application Publication
(10) Pub. No.: US 2011/0296304 A1
(43) Pub. Date: Dec. 1, 2011

(54) Adaptive Gesture Tutorial

(75) Inventor: David D. Kempe, Sunnyvale, CA (US)

(73) Assignee: PALM, INC., Sunnyvale, CA (US)

(21) Appl. No.: 12/789,312

(22) Filed: May 27, 2010

(51) Int. Cl. G06F 3/033; G06F 3/01

(52) U.S. Cl. 715/708; 715/863

(57) ABSTRACT

A system and a method are disclosed for determining and presenting a gesture tutorial comprising audio and/or video presentation on a gesture that is not frequently used by the user. To determine a tutorial, the system determines the user's gesture repertoire comprising information about gestures already learned by the user, e.g., gestures detected a pre-determined number of times on the user's computing device or another computing device associated with the user. The system determines a gesture associated with the user's computing device that is not represented in the gesture repertoire. The system determines a tutorial for the determined gesture and transmits the determined tutorial for presentation to the user.

### BACKGROUND

1. Field of Art

The disclosure generally relates to the field of computing device interfaces, and more specifically, to input gestures supported by the computing device.

2. Description of Art

Mobile computing devices are well known. Mobile computing devices utilize different input mechanisms including keyboards and pointing devices. As the mobile computing devices support more features, the need to provide a simple intuitive user interface to access the supported features becomes more acute. One such interface is a touch screen interface or another interface that senses gestures input by a user. The input gestures, e.g., sliding a finger from left to right or a stroke of a stylus or touch pen, correspond to a particular function as understood by the user and the operating system or an application on the particular device in use by the user.

When a user begins use of a new device, for example, a replacement device to a previous device, the user's new devices may interpret a gesture differently from the previous device. Additionally, the new device may support additional gestures not supported by the previous device. The new device may provide a tutorial for all its supported gestures, but a user is unlikely to sit through a long tutorial presenting all the supported gestures. Moreover, such a tutorial does not account for gestures already known to the user and the functions that the user associates with those gestures.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1a illustrates one embodiment of a mobile computing device in a first positional state.

FIG. 1b illustrates one embodiment of the mobile computing device in a second positional state.

FIG. 2 illustrates one embodiment of an architecture of a mobile computing device.

FIG. 3 illustrates one embodiment of a system for determining and presenting a gesture tutorial on the mobile computing device.

FIG. 4 illustrates one embodiment of an architecture of a tutorial server.

FIG. 5 illustrates one embodiment of an architecture of a tutorial manager on the mobile computing device.

FIG. 6 illustrates one embodiment of a method for determining and presenting a gesture tutorial on the mobile computing device.

FIG. 7 illustrates one embodiment of a method for tracking gestures learned by a user of the mobile computing device.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

One embodiment of a disclosed system (or apparatus, or method or computer readable storage medium) includes instructions for determining and presenting a gesture tutorial, for example, a graphical, audio and/or video presentation, on using (or applying) a gesture that may be new to a user or may not have been frequently used by the user. To determine which tutorial to present, in one embodiment the system determines the user's gesture repertoire comprising information about gestures already learned by the user, e.g., gestures detected a pre-determined number of times on the user's computing device or another computing device with which the user has interacted. The system then determines a gesture associated with the user's computing device that is not represented in the gesture repertoire. Next, the system determines a tutorial corresponding to the determined gesture and transmits the determined tutorial for presentation to the user.

### Example Mobile Computing Device

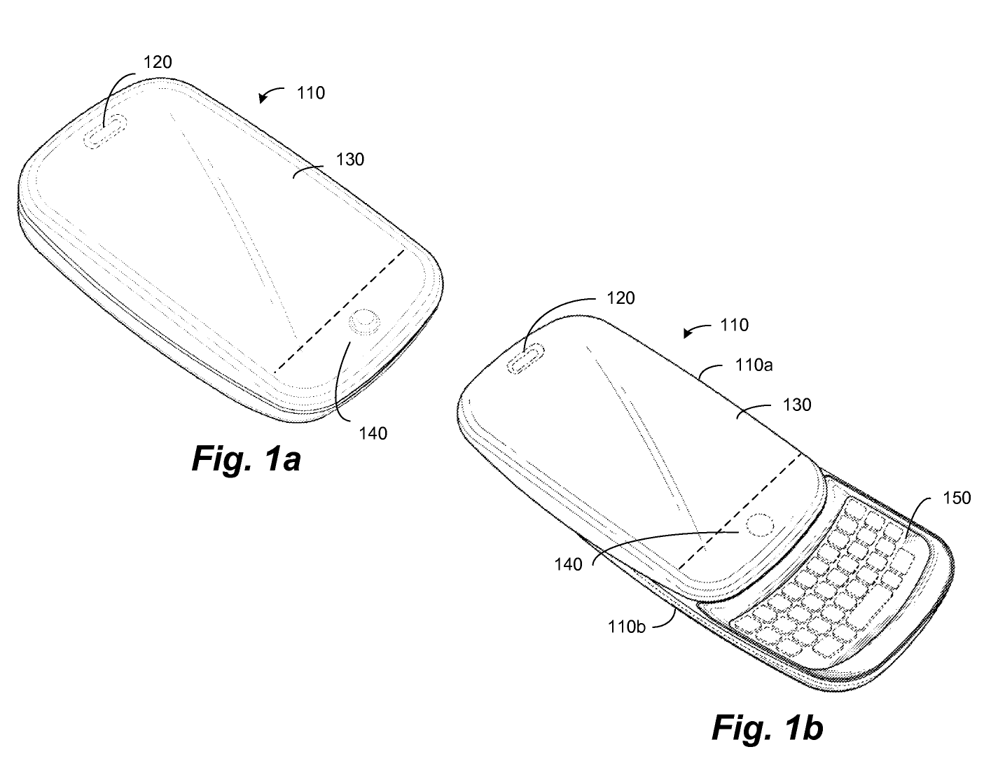

FIGS. 1a and 1b illustrate one embodiment of a mobile computing device 110. FIG. 1a illustrates one embodiment of a first positional state of the mobile computing device 110 having telephonic functionality, e.g., a mobile phone or smartphone. FIG. 1b illustrates one embodiment of a second positional state of the mobile computing device 110 having telephonic functionality, e.g., a mobile phone, smartphone, netbook, or laptop computer. The mobile computing device 110 is configured to host and execute a phone application for placing and receiving telephone calls.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) and/or data networks having voice over internet protocol (VoIP) functionality. Likewise, the mobile computing device 110 is only by way of example, and the principles of its functionality apply to other computing devices, e.g., tablet computer, desktop computers, server computers, media devices and the like. In each of these configurations, the particular computing device, like the mobile computing device 110, includes a screen that is a touch sensitive screen as further described below.

The mobile computing device 110 includes a first portion 110a and a second portion 110b. The first portion 110a comprises a screen for display of information (or data) and may include navigational mechanisms. These aspects of the first portion 110a are further described below. The second portion 110b comprises a keyboard and also is further described below. The first positional state of the mobile computing device 110 may be referred to as an “open” position, in which the first portion 110a of the mobile computing device slides in a first direction exposing the second portion 110b of the mobile computing device 110 (or vice versa in terms of movement). The mobile computing device 110 remains operational in either the first positional state or the second positional state.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch).

The screen 130 of the mobile computing device 110 is, for example, a 240×240, a 320×320, a 320×480, or a 640×480 touch sensitive (including gestures) display screen. The screen 130 can be structured from, for example, such as glass, plastic, thin-film or composite material. The touch sensitive screen may be a transflective liquid crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a touch pen, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130. In addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a dedicated gesture area, which allows for gesture interaction and control of functions and operations shown through a user interface displayed on the screen 130.

The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards). Examples of memory or media card form factors include COMPACTFLASH, SD CARD, XD CARD, MEMORY STICK, MULTIMEDIA CARD, SDIO, and the like.

### Example Mobile Computing Device Architectural Overview

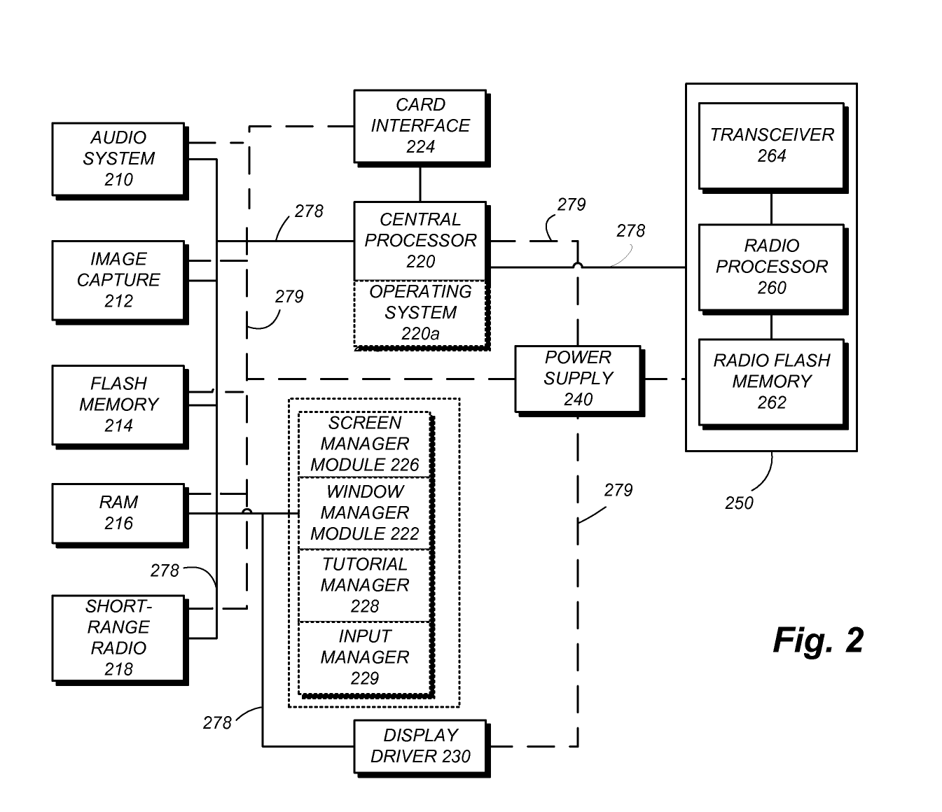

Referring next to FIG. 2, a block diagram illustrates one embodiment of an architecture of a mobile computing device 110, with telephonic functionality. By way of example, the architecture illustrated in FIG. 2 will be described with respect to the mobile computing device of FIGS. 1a and 1b. The mobile computing device 110 includes a central processor 220, a power supply 240, and a radio subsystem 250. Examples of a central processor 220 include processing chips and system based on architectures such as ARM (including cores made by microprocessor manufacturers), ARM XSCALE, AMD ATHLON, SEMPRON or PHENOM, INTEL ATOM, XSCALE, CELERON, CORE, PENTIUM or ITANIUM, IBM CELL, POWER ARCHITECTURE, SUN SPARC and the like.

The central processor 220 is configured for operation with a computer operating system. The operating system is an interface between hardware and an application, with which a user typically interfaces. The operating system is responsible for the management and coordination of activities and the sharing of resources of the mobile computing device 110. The operating system provides a host environment for applications that are run on the mobile computing device 110. As a host, one of the purposes of an operating system is to handle the details of the operation of the mobile computing device 110. Examples of an operating system include PALM OS and WEBOS, MICROSOFT WINDOWS (including WINDOWS 7, WINDOWS CE, and WINDOWS MOBILE), SYMBIAN OS, RIM BLACKBERRY OS, APPLE OS (including MAC OS and IPHONE OS), GOOGLE ANDROID, and LINUX.

The central processor 220 communicates with an audio system 210, an image capture subsystem (e.g., camera, video or scanner) 212, flash memory 214, RAM memory 216, and a short range radio module 218 (e.g., Bluetooth, Wireless Fidelity (WiFi) component (e.g., IEEE 802.11)). The central processor communicatively couples these various components or modules through a data line (or bus) 278. The power supply 240 powers the central processor 220, the radio subsystem 250 and a display driver 230 (which may be contact- or inductive-sensitive). The power supply 240 may correspond to a direct current source (e.g., a battery pack, including rechargeable) or an alternating current (AC) source. The power supply 240 powers the various components through a power line (or bus) 279.

The central processor communicates with applications executing within the mobile computing device 110 through the operating system 220a. In addition, intermediary components, for example, a window manager module 222, a screen manager module 226, a tutorial manager 228 and an input manager 229 provide additional communication channels between the central processor 220 and operating system 220 and system components, for example, the display driver 230.

In one embodiment, the window manager module 222 comprises a software (e.g., integrated with the operating system) or firmware (lower level code that resides in a specific memory for that code and for interfacing with specific hardware, e.g., the processor 220). The window manager module 222 is configured to initialize a virtual display space, which may be stored in the RAM 216 and/or the flash memory 214. The virtual display space includes one or more applications currently being executed by a user and the current status of the executed applications. The window manager module 222 receives requests, from user input or from software or firmware processes, to show a window and determines the initial position of the requested window. Additionally, the window manager module 222 receives commands or instructions to modify a window, such as resizing the window, moving the window or any other command altering the appearance or position of the window, and modifies the window accordingly.

The screen manager module 226 comprises a software (e.g., integrated with the operating system) or firmware. The screen manager module 226 is configured to manage content that will be displayed on the screen 130. In one embodiment, the screen manager module 226 monitors and controls the physical location of data displayed on the screen 130 and which data is displayed on the screen 130. The screen manager module 226 alters or updates the location of data as viewed on the screen 130. The alteration or update is responsive to input from the central processor 220 and display driver 230, which modifies appearances displayed on the screen 130. In one embodiment, the screen manager 226 also is configured to monitor and control screen brightness. In addition, the screen manager 226 is configured to transmit control signals to the central processor 220 to modify power usage of the screen 130.

The input manager 229 comprises software that is, for example, integrated with the operating system or configured to be an application operational with the operating system. In some embodiments it may comprise firmware, for example, stored in the flash memory 214. The input manager 229 receives user input from the keypad 150, the touch sensitive screen 130 or another input device communicatively coupled to or integrated within the mobile computing device 110. The input manager 229 translates the received input into signals that can be interpreted by various modules within the mobile computing device 110 and then transmits the signals to the appropriate module. For example, when the screen manager 226 is displaying a window related to the gesture tutorial on screen 130, the input manager 229 receives user input from the screen 130, translates the input and transmits the input to the tutorial manager 228.

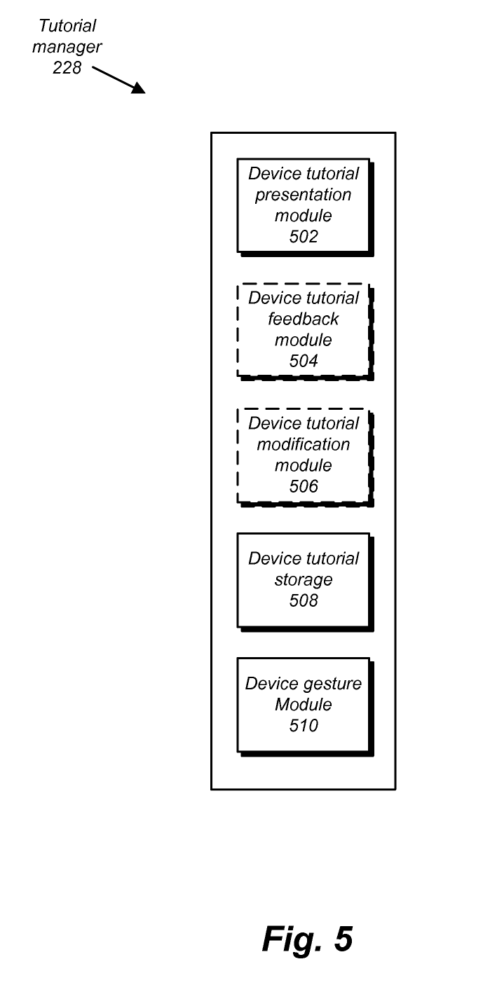

The tutorial manager 228 comprises software that is, for example, integrated with the operating system or configured to be an application operational with the operating system. In some embodiments it may comprise firmware, for example, stored in the flash memory 214. The tutorial manager 228 receives information about the user profile, determines or receives a tutorial for teaching various gestures to the user based on the received user information, and presents the tutorial through the mobile computing device 110 to the user. In one embodiment, the tutorial manager 228 determines the tutorial based on the information stored within the mobile computing device 110. In another embodiment, the tutorial manager 228 determines the tutorial based on the information received from a remote server or retrieved from a remote database. The tutorial manager is described in further detail in description of FIG. 5 below.

It is noted that in one embodiment, central processor 220 executes logic (e.g., by way of programming, code, or instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) mobile (or greater), High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using the data line (or bus) 278.

The card interface 224 is adapted to communicate, wirelessly or wired, with external accessories (or peripherals), for example, media cards inserted into the expansion slot (not shown). The card interface 224 transmits data and/or instructions between the central processor and an accessory, e.g., an expansion card or media card, coupled within the expansion slot. The card interface 224 also transmits control signals from the central processor 220 to the expansion slot to configure the accessory. It is noted that the card interface 224 is described with respect to an expansion card or media card; it also may be structurally configured to couple with other types of external devices for the device 110, for example, an inductive charging station for the power supply 240 or a printing device.

### Example Tutorial System Overview

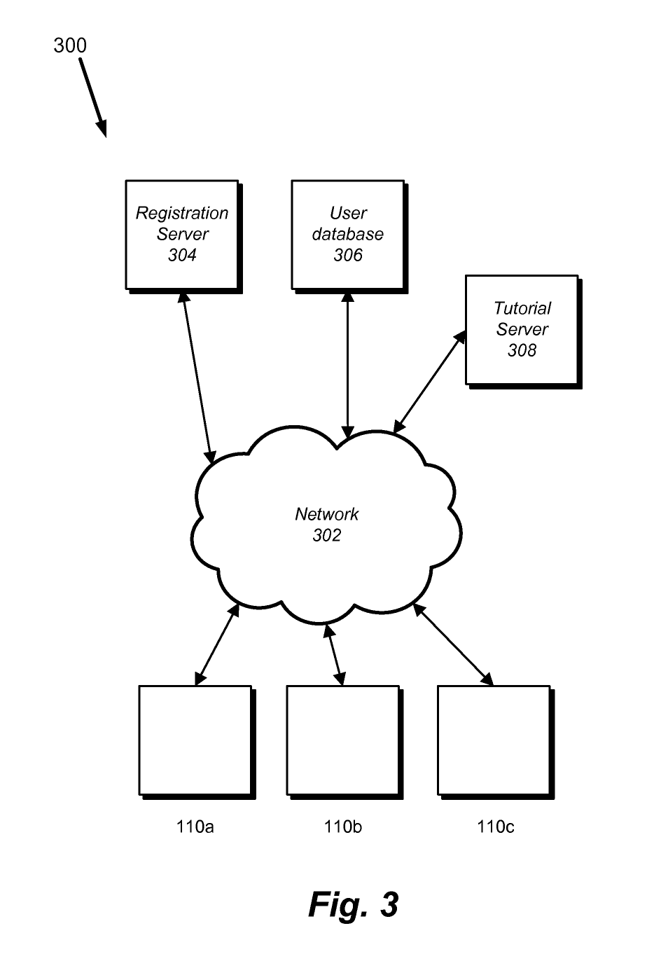

Referring now to FIG. 3, it illustrates one embodiment of a system for determining and presenting a gesture tutorial on the mobile computing device. The system 300 comprises a registration server 304, a user database 306, a tutorial server 308 and the mobile computing devices 110a-c. All these entities are communicatively coupled to each other through network 302. Moreover, the registration server 304, the user database 306 and the tutorial server 308 are hardware, software or firmware implementations that perform the functionality described below.

The registration server 304 receives registration information from mobile computing devices 110a-c typically when the devices 110a-c are used for the first time. In one embodiment, the registration server 304 receives the registration information responsive to a mobile computing device 110a-c receiving a selection indicating that the user of mobile computing device 110a-c wants to register the device 110a-c. The registration information comprises a user identification associated with a user of the mobile computing device 110a-c and a device identification associated with the mobile computing device 110a-c. Alternatively, the registration information comprises multiple user identifications, each corresponding to a different user that uses the same mobile computing device 110a-c. In one embodiment, the registration information also includes an operating system identification corresponding to the operating system on the mobile computing device 110a-c. Alternatively, the operating system identification also indicates the version of the operating system on the mobile computing device 110a-c. The registration server 304 receives the registration information, registers the user(s) based on the received information and stores the received registration information in the user database 306.

The user database 306 stores information about mobile computing devices 110a-c and the users associated with the mobile computing devices 110a-c. The user database 306 stores the registration information received from the registration server 304. Additionally, the user database 304 also receives from the mobile computing device 110a-c information about the user's repertoire. The user repertoire information includes identification for the gestures determined to be learned by the user. Alternatively, the user repertoire information also includes the function associated with the gesture. In one embodiment, the user repertoire information also includes an identification of the mobile computing device 110a-c that receives the gestures from the user while the user is learning the gesture. Similarly, the user repertoire information, in another embodiment, includes identification of the application on the mobile computing device 110a-c or the operating system on the mobile computing device 110a-c that receives the gesture from the user while the user is learning the gesture. For example, the user repertoire information can include an identification for a linear gesture from right to left and an associated function that directs the application or the operating system associated with the gesture to scroll from right to left. Additionally, the example user repertoire information can include an identification for the mobile computing device 110a-c (e.g., PALM PRE or MOTOROLA DROID), an identification for the operating system (e.g., PALM WEBOS, GOOGLE ANDROID, or WINDOWS MOBILE 7), or an identification for the application that received the gesture while the user was learning the gesture.

Accordingly, whenever the user registers a new device or learns a new gesture, the user database 306 stores the information about the new device or the new gesture learned by the user. In this manner, the user database 306 accumulates information about various gestures learned by the user and various mobile computing devices 110a-c used by the user. As discussed below, this accumulated device history and gesture history beneficially enables the system 300 to prepare user specific tutorials to teach the user newly available gestures associated with the user's current mobile computing device 110a-c.

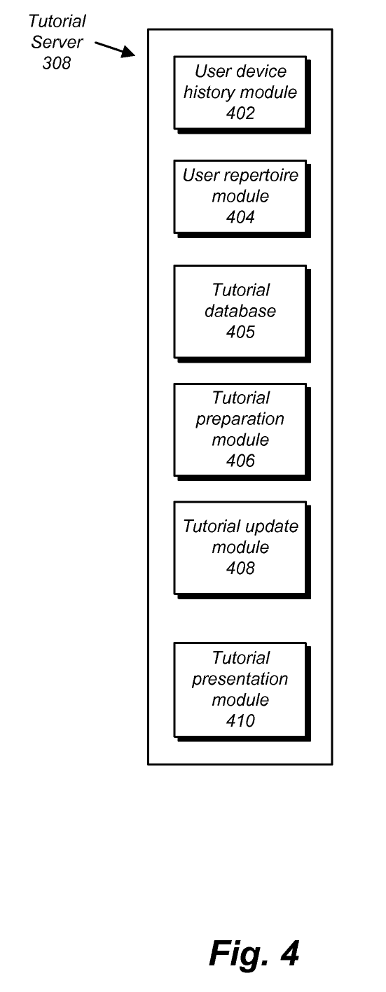

The tutorial server 308 creates a gesture tutorial for teaching the user of mobile computing device 110a-c various gestures that are either new to the user or has been sparsely used by the user in the past. A gesture tutorial is a visual (e.g., graphical or video) and/or audio presentation that teaches the user how to use one or more gestures. After a device registration, the tutorial server 308 receives a signal from the registration server 304 indicating that the user has registered a new mobile computing device 308. Alternatively, the tutorial server 308 repeatedly polls the user database 306 for new registrations. Regardless of how the tutorial server 308 determines that a user has registered a new device 110a-c, the tutorial server 308 retrieves from the user database 306 the registration information, the device history and the gesture history associated with the user. Based on this retrieved information, the tutorial server 308 prepares a gesture tutorial tailored for the user and transmits the tutorial to the mobile computing device 110a-c of the user. The tutorial server 308 is further described with respect to FIG. 4 below.

The network 302 is a collection of computers, routers and other digital devices communicatively coupled to each other through various communication channels. The network 302 facilitates transmission of digital data between various devices connected to the network 302. The mobile computing devices 110a-c have been described above with respect to FIGS. 1a, 1b, and 2.

### Tutorial Server

Referring to FIG. 4, it illustrates one embodiment of the tutorial server 308. The tutorial server 308 comprises a user device history module 402, a user repertoire module 404, a tutorial preparation module 406, a tutorial update module 408, a tutorial presentation module 410 and a tutorial database 405. All these modules and database are hardware, firmware or software implementations that perform various tasks described below.

The user device history module 402 receives a user identification from the tutorial preparation module 406, queries the user database 306 and determines various mobile computing devices 110a-c previously registered by the user. Alternatively, the user device history module 402 also queries the user database 306 to determine various gestures supported by the previously registered computing devices 110a-c or applications on the previously registered computing devices 110a-c. Additionally, the user device history module 402 also retrieves from the user database 306 the functions corresponding to the supported gestures. The user device history module 402 transmits this determined information to the user repertoire module 404.

The user repertoire module 404 receives a user identification from the tutorial preparation module 406, queries the user database 306 and determines the user repertoire information associated with the received user identification. The user repertoire module 404 transmits the determined user repertoire information to the tutorial preparation module 406. The user repertoire module 404 also receives from the user's current mobile computing device 110a-c an identification of a gesture that has recently been learned by the user. In one embodiment, the user repertoire module 404 repeatedly receives the identifications of gestures recently received by the current operating system and corresponding mobile computing device 110a-c as inputs from the user. The user repertoire module 404 repeatedly saves the recently received gesture identifications and determines from the recently received gesture identifications a gesture that has been used by the user a pre-determined amount of times. The user repertoire module 404 identifies such a gesture as a learned gesture by the user and updates the user repertoire information in the user database 306 with the identification of the newly learned gesture. In one embodiment, the user repertoire module 404 queries the user device history module 402 and determines the function associated with the gesture in the current mobile computing device 110a-c. The user repertoire module 404 then updates the user repertoire information in user database 306 with the function corresponding to the newly learned gesture. Alternatively, the user repertoire module 404 also queries the user database 306 and determines if any of the functions associated with the user's learned gestures in the current device 110a-c are different from the functions corresponding to the user's learned gestures associated with the user's previous devices 110a-c. If yes, the user repertoire module 404 updates the user repertoire information by removing such gestures from the list of user's learned gestures. Later, the user repertoire module 404 transmits the updated user repertoire information to the tutorial preparation module 406.

The tutorial database 405 stores identification for various mobile computing devices 110a-c, a list of gestures supported by the OS of the mobile computing device 110a-c and, alternatively, by various applications associated with the mobile computing device 110a-c. Additionally, the tutorial database 405 stores tutorials, i.e. audio and/or visual presentations, for teaching a user how to use the gesture on the mobile computing device 110a-c. Examples of tutorials include a presentation file (e.g., MICROSOFT POWERPOINT or ADOBE FLASH file), a video file (e.g., an MPEG-4 or APPLE QUICKTIME file), or an audio file (e.g., WINDOWS MEDIA AUDIO, APPLE iTUNES, or MP3 file) that includes instructions or information about a gesture. The tutorial database 405 is populated with these tutorials through a client application (not shown) or another interface (not shown). In one embodiment, the tutorial database 405 is updated with tutorials by a mobile device manufacturer. In another embodiment, the tutorial database 405 is updated with tutorials by the application developers or the operating system developers.

The tutorial preparation module 406 determines that a user has registered a mobile computing device 110a-c, and consequently, the tutorial preparation module 406 prepares a gesture tutorial for the user. The tutorial preparation module 406 determines that a user has registered a mobile computing device 110a-c by repeatedly polling the user database 306 or by receiving a signal from the registration server 304. Alternatively, the tutorial preparation module 406 receives a signal from the mobile computing device 110a-c requesting the gesture tutorial. In one embodiment, the mobile computing device 110a-c transmits the request responsive to receiving the request from the user. In another embodiment, the mobile computing device 110a-c transmits the request responsive to an updated or an installation of an operating system or an application on the mobile computing device 110a-c.

Responsive to determining the new registration or receiving the tutorial request, the tutorial preparation module 406 retrieves the user repertoire information from the user repertoire module 404 and prepares the gesture tutorial based on the retrieved information. The tutorial preparation module 406 queries the user device history module 402 and determines the current mobile device 110a-c associated with the user's identification and determines the gestures associated with the current mobile device 110a-c. The tutorial preparation module 406 then queries the user repertoire module 404 and determines the user repertoire information including the list of gestures already learned by the user. Next, the tutorial preparation module 406 compares the list of gestures associated with the current mobile device 110a-c to the list of gestures already learned by the user. The tutorial preparation module 406 then retrieves from the tutorial database 405 the tutorials for the list of gestures associated with the current mobile device 110a-c but not yet learned by the user of the current mobile device 110a-c. In one embodiment, the tutorial preparation module 406 retrieves tutorials for a pre-determined number of gestures that have not been learned by the users and that are most frequently used by other users. In this manner, the tutorial preparation module 406 beneficially limits the amount of gestures being taught to the user in a tutorial and therefore increases the chances of the user retaining the taught gestures in the tutorial. The tutorial preparation module 406, in one embodiment, then combines the retrieved tutorials into one tutorial. For example, in case the tutorials included FLASH presentations for the determined gestures, the tutorial preparation module 406 combines the FLASH presentations for one or more determined gestures. Alternatively, the tutorial preparation module 406 keeps separate the tutorials for the determined gestures. The tutorial preparation module 406 then transmits the combined or separate tutorials to the tutorial presentation module 410.

The tutorial presentation module 410 retrieves the prepared tutorials from the tutorial preparation module 406 and transmits the list to the user's current mobile device 110a-c. In one embodiment, the tutorial presentation module 410 transmits an initial part of the tutorial to the current mobile device 110a-c, and then transmits the next tutorial part after receiving a request for the next part from the mobile computing device 110a-c. In another embodiment, the tutorial presentation module 410 transmits the tutorials to the mobile computing device 110a-c in one or more parts without receiving any intermediary requests for various parts of the tutorials. For example, the prepared tutorial for a plurality of gestures includes a plurality of FLASH slides for each gesture. The tutorial presentation module 410 can transmit slides for each gesture as a part, or each slide as a part or the whole FLASH presentation as one part. The transmitted tutorials, in one embodiment, prompt the user for input in response to various parts of the tutorial and the received user's input is saved as tutorial feedback.

The tutorial update module 408 receives tutorial feedback from the mobile computing device 110a-c and updates the tutorials based on the received feedback. For example, if the tutorial feedback indicates that the user did not learn how to use a gesture after the initial tutorial presentation, the tutorial update module 408 creates a new tutorial or modifies the previously transmitted tutorial for teaching that gesture. The tutorial update module 408 transmits the created or modified tutorial to mobile computing device 110a-c.

### Tutorial Manager

Referring to FIG. 5, it illustrates one embodiment of the tutorial manager 228 on the mobile computing device 110a-c. The tutorial manager 228 determines and presents the tutorial for one or more gestures on the user's current mobile computing device 110a-c. In one embodiment, the tutorial manager 228 communicates with the tutorial server 308 to determine a tutorial for a user. In another embodiment, the tutorial manager 228 determines the tutorial without the help of the tutorial server 308. Both the embodiments are further described below.

The tutorial manager 228 comprises a device tutorial presentation module 502, a device tutorial storage module 506 and a device gesture module 510. Alternatively, the tutorial manager 228 also comprises a device tutorial feedback module 504 and a device tutorial modification module 506. All these modules and storage are hardware, firmware, software or blended implementations that perform various tasks described below.

The device tutorial presentation module 502 receives the tutorial from the tutorial presentation module 410 in tutorial server 308 and the device tutorial presentation module 502 stores the received tutorial in device tutorial storage 508. The device tutorial presentation module 502 then presents the stored tutorial to the user of the mobile computing device 110a-c.

In one embodiment, the tutorial manager 228 does not receive the tutorial from the tutorial server 308. In this embodiment, the device tutorial presentation module 502 includes all or some of the functionality of the user device history module 402, the user repertoire module 404 and the tutorial presentation module 406. Accordingly, the device tutorial presentation module 502 determines the new user's registration or receives a signal from input manager 229 indicating that the user has requested a tutorial. Next, the device tutorial presentation module 502 determines the tutorials for the list of gestures associated with the user's current mobile device 110a-c but not yet learned by the user. The process for such determination has been described above with respect to the tutorial preparation module 406. The tutorial presentation module 502 stores the determined tutorial in the device tutorial storage 508 and then presents the determined storage to the user.

The device tutorial feedback module 504 receives feedback from the user regarding the tutorial presentation and transmits the feedback to the tutorial update module 408. Again, the transmitted feedback is used to create an updated tutorial if necessary. In one embodiment, the tutorial presentation includes a quiz to determine whether the user has learned the gesture being taught in the presentation. The device tutorial feedback module 504 receives user's responses to the quiz and transmits the received responses as feedback to the tutorial update module 408.

In one embodiment, the tutorial manager 228 does not receive the tutorial from the tutorial server 308 and the device tutorial feedback module 504 does not transmit the feedback to the tutorial update module 408 in the tutorial manager 228. Instead, the device tutorial feedback module 504 transmits the feedback to the device tutorial modification module 506.

The device tutorial modification module 506 receives the feedback from the device tutorial feedback module 504 and creates a new tutorial or modifies an existing tutorial based on the received feedback. The device tutorial modification module 506 then transmits for presentation to the user the created or modified tutorial to the tutorial presentation module 502.

The device tutorial storage 508 receives and stores the tutorial presentations from the device tutorial presentation module 502. In one embodiment, the tutorial manager 228 does not receive the tutorial from the tutorial server 308. In this embodiment, the device tutorial storage 508 also stores a list of gestures supported by the OS of the mobile computing device 110a-c and, alternatively, by various applications associated with the mobile computing device 110a-c. Additionally, the device tutorial storage 508 stores tutorials, e.g., audio and/or visual presentations, for teaching a user how to use the gesture on the mobile computing device 110a-c. Again, examples of tutorials formats are described above and include instructions or information about a gesture. Moreover, in the embodiment where the tutorial manager 228 does not receive the tutorial from the tutorial server 308, the device tutorial storage 508 is populated with tutorials in the same manner described above for the tutorial database 405. Additionally, in this embodiment, the device tutorial presentation module 502 determines the tutorial for the user based on the stored tutorials in the device tutorial storage 508. Furthermore, in one embodiment, the device tutorial storage 508 also receives and stores tutorial presentations from the device tutorial modification module 510.

The device gesture module 510 repeatedly receives from the input manager 229 the gestures input by the user. The device gesture module 510 saves an identification for the received gesture and determines from the saved gesture identifications a gesture that has been used by the user a pre-determined amount of times. The device gesture module 510 identifies such a gesture as a learned gesture by the user and transmits the identification for the learned gesture to the user repertoire module 404 in the tutorial server 308. Again, the tutorial server 308 uses this received information to create a tutorial presentation for the user. In one embodiment, the tutorial server 308 does not create the tutorial presentation and the tutorial manager 228 does not receive the tutorial from the tutorial server 308. In this embodiment, the device gesture module 510 transmits the identification for the learned gesture to the device tutorial presentation module 502 for use in creating the tutorial presentation. The device tutorial presentation module 502 uses the received information in a similar manner as the tutorial server 308 to create the tutorial presentations.

### Example Tutorial Creation and Presentation Methodology

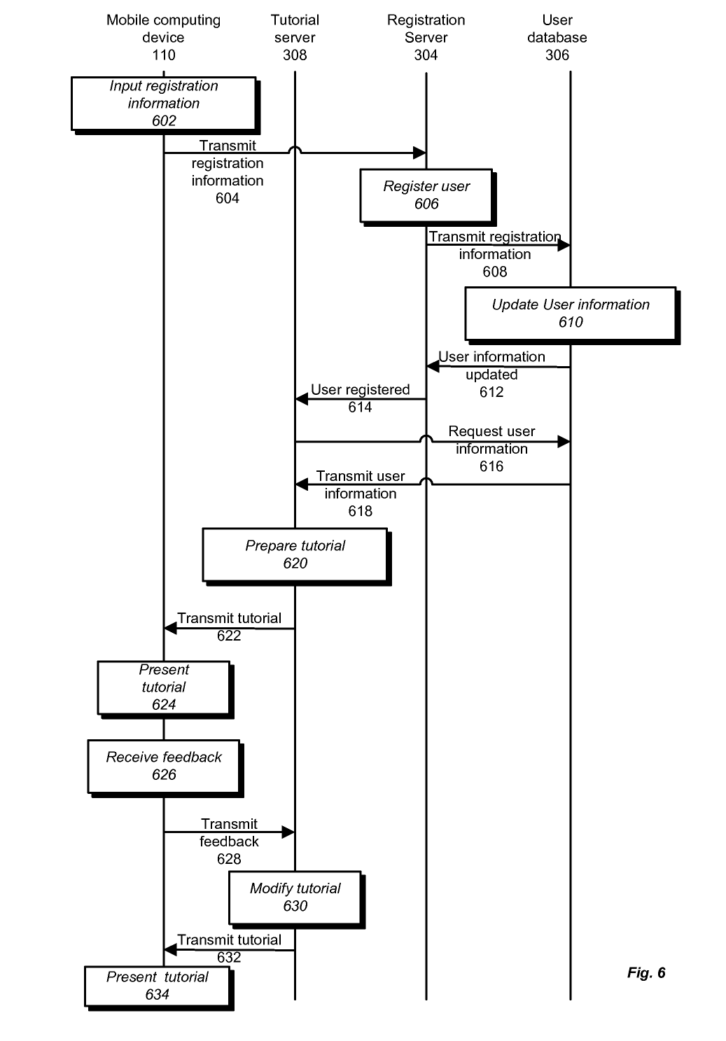

Referring to FIG. 6, it illustrates one embodiment of a method for determining and presenting a gesture tutorial on the mobile computing device 110a-c. The method begins with the mobile computing device 110a-c receiving 602 registration information from a user. The mobile computing device 110a-c transmits 604 the received information to the registration server 304. Next, the registration server 304 registers 606 using the received information the user or the mobile computing device 110a-c and transmits 608 the registration information to user database 306. The user database 306 stores 610 the received information and transmits 612 a signal to the registration server 304 indicating that the user information has been updated. In one embodiment, step 612 is skipped and the registration server 304 assumes that the user information has been updated after the registration server 304 transmits the information to user database 306.

Next, the registration server 304 transmits 614 a signal to the tutorial server 308 indicating that the user has been registered. Consequently, the tutorial server 308 queries 306 and receives 308 from the user database 306 the information associated with the registered mobile computing device 110a-c or the user associated with the registered mobile computing device 110a-c. Based on the received information, the tutorial server 308 creates 620 a gesture tutorial and transmits 622 the created tutorial to the mobile computing device 110a-c. The mobile computing device 110a-c presents 624 the received tutorial to the user and receives 626 feedback related to the tutorial from the user. The mobile computing device then transmits 628 the received feedback to the tutorial server 308 and the tutorial server 308 modifies 630 the previously existing tutorial or creates 630 a new tutorial based on the received feedback. The tutorial server 308 then transmits 632 the modified or newly created tutorial to the mobile computing device 110a-c and the mobile computing device 110a-c presents 634 the received tutorial to the user. In one embodiment, steps 628-634 are implemented repeatedly until the received feedback indicates that the user has learned the gesture being taught in the tutorial or that the user wishes to exit the tutorial.

The method above illustrates preparation and presentation of a tutorial in response to registration of a mobile computing device 110a-c. One of ordinary skill in the art will understand that steps 620-634 can be performed in response to additional events like installation of an update of or a new installation of an application or the operating system of the mobile computing device 110a-c. Additionally, in one embodiment, the above illustrated method is used for preparing different tutorials for different users of the same mobile device 110a-c. In this embodiment, the user logs into the mobile computing device 110a-c, the tutorial server 308 receives the user login and prepares the tutorial specific to the received user login. Moreover, in the illustrated method, the tutorial server 308 prepares and modifies the tutorial. As discussed above, in one embodiment, the tutorial is instead prepared or modified by the mobile computing device 110a-c.

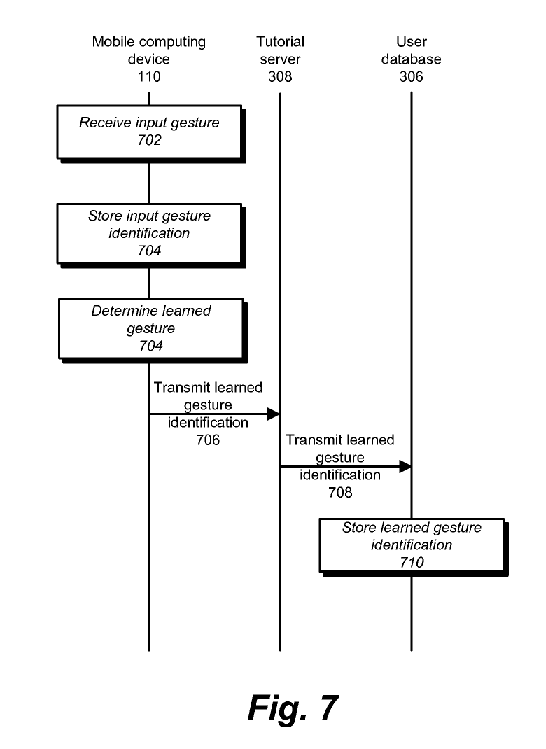

Referring to FIG. 7, it illustrates one embodiment of a method for tracking gestures learned by a user of the mobile computing device 110a-c. The method begins with the mobile computing device 110a-c receiving 702 a gesture and storing 704 an identification for the received gesture. Next, the mobile computing device 110a-c determines the number of times the mobile computing device 110a-c has received and stored the identification for the same gesture. If the mobile computing device 110a-c has received the same gesture from the user a pre-determined number of times, the mobile computing device 110a-c determines 704 that the user has learned that gesture. Accordingly, the mobile computing device 110a-c marks that gesture as a learned gesture and transmits 706 to the tutorial server 308 the identification for the learned gesture. The tutorial server 308 transmits 708 the received identification to user database 306 and the user database 306 stores 710 the received identification for the learned gesture. In one embodiment, the mobile computing device 110a-c does not communicate with the tutorial server 308 and therefore does not transmit the identification of the learned gesture to the tutorial server 308 at step 706. Instead, the mobile computing device 110a-c directly transmits the identification to the user database 306. In this manner, the user database stores an identification for the gestures learned by a user and the tutorial server 308 or the mobile computing device 110a-c use this stored information to determine a tutorial for gestures not learned by the user.

The disclosed embodiments beneficially allow for creation of a user specific tutorial that accounts for the gestures already learned by the user. Accordingly, the created tutorial does not repeat information already known to the user and therefore is more likely to be shorter in length and more likely to hold the user's attention.

Some portions of above description describe the embodiments in terms of algorithms and symbolic representations of operations on information, for example, as illustrated and described with respect to FIGS. 6-7. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Moreover, many details about the mobile computing device are described for illustration purposes and these details are not required for implementing the claims system and method. For example, the physical dimensions of the mobile computing device, components like speakers and keypad in the mobile computing device are illustrated but not required. These illustrated details are meant to provide contextual description and are not necessary for enabling the claimed systems and methods. Accordingly, such details should not be read as limiting the claimed systems and methods.

Additionally, the method of determining and presenting a user specific gesture tutorial is illustrated in context of using a mobile computing device. One of ordinary skill in the art will understand that the disclosed system and method can also be used for determining and presenting a user specific gesture tutorial supported by computing devices that may not be considered a mobile device, but which have operating system and screens designed to receive gesture interactions.

Upon reading this disclosure, those of skill in the art will appreciate still additional alternative structural and functional designs for a system and a process for creating a gesture tutorial tailored for a particular user through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for determining a tutorial presentation for users of computing devices, the method comprising:
determining a gesture repertoire of a user associated with a computing device, the gesture repertoire representing gesture information associated with gestures detected a pre-determined number of times on the computing device or another computing device associated with the user;
determining a gesture associated with the computing device wherein the determined gesture is not represented in the gesture repertoire;
determining a tutorial presentation corresponding to the determined gesture; and
transmitting the determined tutorial presentation to a presentation module in the computing device for presentation to the user.

2. The method of claim 1, further comprising:
receiving feedback indicating that the user did not learn the determined gesture;
modifying the determined tutorial presentation or creating a new tutorial presentation based on the received feedback; and
transmitting the modified or newly created tutorial presentation.

3. The method of claim 1, further comprising receiving information about a learned gesture for inclusion in the gesture repertoire, the learned gesture corresponding to a gesture detected on the computing device a pre-determined number of times.

4. The method of claim 1, wherein the gesture associated with the computing device is supported by an operating system or an application on the computing device.

5. The method of claim 1, wherein the tutorial presentation is presented to the user responsive to an installation or update of an operating system on the computing device.

6. The method of claim 1 wherein determining the tutorial presentation further comprises determining the tutorial presentation responsive to an update or installation of an application on the computing device.

7. The method of claim 1 wherein a plurality of users are associated with the computing device, the method further comprising:
receiving an identification associated with one of the plurality of the users; and
wherein determining the gesture repertoire comprises determining the gesture repertoire associated with the received identification associated with one of the plurality of the users.

8. A computer readable storage medium storing instructions thereon, the instructions executed by one or more processors cause the processors to:
determine a gesture repertoire of a user associated with a computing device, the gesture repertoire representing gesture information associated with gestures detected a pre-determined number of times on the computing device or another computing device associated with the user;
determine a gesture associated with the computing device wherein the determined gesture is not represented in the gesture repertoire;
determine a tutorial presentation corresponding to the determined gesture; and
transmit the determined tutorial presentation to a presentation module in the computing device for presentation to the user.

9. The computer readable storage medium of claim 8, further comprising instructions executed by the one or more processors cause the processors to:
receive feedback indicating that the user did not learn the determined gesture;
modify the determined tutorial presentation or create a new tutorial presentation based on the received feedback; and
transmit the modified or newly created tutorial presentation.

10. The computer readable storage medium of claim 8, further comprising instructions executed by the one or more processors cause the processors to receive a learned gesture for inclusion in the gesture repertoire, the learned gesture corresponding to a gesture detected on the computing device a pre-determined number of times.

11. The computer readable storage medium of claim 8, wherein the gesture associated with the computing device is supported by an operating system or an application on the computing device.

12. The computer readable storage medium of claim 8, wherein the tutorial presentation is presented to the user responsive to an installation or update of an operating system on the computing device.

13. The computer readable storage medium of claim 8, wherein determining the tutorial presentation further comprises determining the tutorial presentation responsive to an update or installation of an application on the computing device.

14. The computer readable storage medium of claim 8, wherein a plurality of users are associated with the computing device, further comprising instructions executed by the processor cause the processor to:
receive an identification associated with one of the plurality of the users; and
wherein determining the gesture repertoire comprises determining the gesture repertoire associated with the received identification associated with one of the plurality of the users.

15. A computer-implemented method for determining a tutorial presentation for a user of a computing device, the method comprising:
receiving a tutorial presentation comprising instructions on use a gesture not included in a gesture repertoire, the gesture repertoire representing gesture information associated with gestures detected a pre-determined number of times on the computing device or another computing device associated with the user;
storing the received tutorial presentation; and
presenting the received tutorial responsive to registration of the computing device or installation or an update of an application or an operating system on the computing device.

16. The method of claim 15, further comprising:
transmitting feedback indicating that the user did not learn the gesture taught in the tutorial presentation;
receiving a modified tutorial presentation or a new tutorial presentation based on the transmitted feedback; and
presenting the modified or newly created tutorial presentation to the user.

17. The method of claim 15, further comprising:
determining a learned gesture corresponding to a gesture detected on the computing device a pre-determined number of times; and
transmitting an identification of the learned gesture for inclusion in the gesture repertoire.

18. The method of claim 15, wherein the gesture in the tutorial presentation is supported by an operating system or an application on the computing device.

19. The method of claim 15, wherein the tutorial presentation is presented to the user responsive to an installation or update of an operating system on the computing device.

20. The method of claim 15, wherein receiving the tutorial presentation further comprises receiving the tutorial presentation responsive to an update or installation of an application on the computing device.
